(19) United States
(12) Patent Application Publication
(10) Pub. No.: US 2008/0127606 A1
(43) Pub. Date: Jun. 5, 2008

(54) Wooden door

(75) Inventor: Yoichiro Kuroiwa, Bunkyo-ku (JP)

Correspondence Address: SUGHRUE MION, PLLC, 2100 PENNSYLVANIA AVENUE, N.W., SUITE 800, WASHINGTON, DC, 20037, US

(73) Assignees: KUROIWA KENZAI KENKYUSHO CO., LTD.; RD KUROIWA KENZAI CO., LTD.

(21) Appl. No.: 11/606,144

(22) Filed: Nov. 30, 2006

(51) Int. Cl. B60J 5/00

(52) U.S. Cl. 52/784.14; 52/71

(57) ABSTRACT

A core material having a structure in which three paulownia plates are laminated, the thickness of the inner paulownia plate being larger than the thickness of each of the outer paulownia plates; a core material for a wooden door which applies the above core material as a core material for a wooden door; and a wooden door having surface materials joined to both surfaces of the core material for a wooden door.

### BACKGROUND OF THE INVENTION

1. Field of the Invention

This invention relates to a wooden door which uses a core material for a wooden door applied as a door for a dwelling house, the core material being composed of, for example, a paulownia material, and which obviates the need for a reinforcing material (also called a reinforcement), such as a skeleton or a framing.

2. Description of the Related Art

Wooden doors have hitherto been used as doors for dwelling houses. The wooden door uses a plank of natural wood to give an upscale image, but is costly. Recently, therefore, a proposal has been made for a wooden door which comprises a core material composed of a plurality of laminated wooden plates, and a reinforcement (rail frame, stile frame) provided as a framework for the core material so as to surround the core material (see, for example, Japanese Unexamined Patent Publication No. 2004-232449).

Such a wooden door using the core material comprising the plurality of wooden plates, however, has posed the problem that the core material warps, eventually causing the entire door to warp. This warpage of the door is considered to be a phenomenon caused by the migration of moisture within the wood from the warm side of the wood to the cool side of the wood, thereby expanding the wood on the cool side.

In order to prevent the above-mentioned warpage of the door, it has been customary practice to provide the reinforcement so as to surround the-core material. However, this practice has been still unsuccessful in fully preventing the warpage of the door.

In recent years, cost reduction has been required for wooden doors. However, the use of the reinforcement has increased the number of members constituting the wooden door, and has also increased man-hours for production, resulting in a cost increase.

The present invention has been accomplished in the light of the above-mentioned circumstances. It is an object of the present invention to provide a core material which obviates the necessity for a reinforcement, such as a skeleton or a framing, and can effectively prevent warpage, and to provide a wooden door which can effectively prevent the occurrence of warpage in the entire door, and can achieve cost reduction.

### SUMMARY OF THE INVENTION

A first aspect of the present invention, for attaining the above object, is a wooden door, comprising:

a core material for a wooden door, the core material

having a structure in which three paulownia plates are laminated,

having a shape of a door,

being structured such that a thickness of the inner paulownia plate is larger than a thickness of each of the outer paulownia plates, and

having a three-layer crosswise laminate structure in which the three paulownia plates are laminated, with grains of the three paulownia plates being crossed, the direction of the grain of the inner paulownia plate is a course direction, and the direction of the grain of each of the outer paulownia plates is a wale direction orthogonal to the direction of the grain of the inner paulownia plate;

a surface material joined to a surface of the core material for a wooden door; and

a hinge mounted on the core material for a wooden door without a framing serving as an intermediary.

A second aspect of the present invention is the wooden door according to the first aspect, wherein the thickness of the inner wooden plate is at least 1.5 times the thickness of the outer wooden plate.

A third aspect of the present invention is the wooden door according to the first or second aspect, wherein the thickness of the inner wooden plate is at least 2.0 times the thickness of the outer wooden plate.

A fourth aspect of the present invention is the wooden door according to any one of the first to third aspects, wherein the hinge is fixed to an anchor member mounted on an end portion of the core material for a wooden door.

According to the present invention, the core material is composed of the three paulownia plates, the thickness of the inner wooden plate is larger than the thickness of each of the outer wooden plates, the core material has a three-layer crosswise laminate structure in which the three paulownia plates are laminated, with their grains being crossed, and the direction of the grain of the inner paulownia plate is a course direction, while the direction of the grain of each of the outer paulownia plates is a wale direction orthogonal to the direction of the grain of the inner paulownia plate. Consequently, occurrence of a warp in the core material can be effectively prevented in an environment with a great temperature difference between the front side and the back side of the core material, even when a reinforcement, such as a skeleton or a framing, is not provided in the core material. By applying such a core material as a core material for a wooden door, warpage can be prevented as in the above core material. In the wooden door of the present invention, which has been prepared using such a core material for a wooden door, warpage of the core material for a wooden door can be effectively prevented in an environment with a great temperature difference between the front side and the back side of the door. This produces the effect of enhancing the shape stability of the door.

In the wooden door of the present invention, a reinforcement for the core material is unnecessary, so that the number of the components can be decreased, and the effect of achieving cost reduction is also obtained.

### BRIEF DESCRIPTION OF THE DRAWINGS

For a more complete understanding of the present invention and the advantages thereof, reference is now made to the following descriptions in conjunction with the accompanying drawings.

FIG. 1 is an enlarged sectional view of essential parts of a core material according to Example 1 of the present invention.

FIGS. 2A and 2B are views showing the status of installation of Specimens A and B in a durability test.

FIG. 3 is an enlarged sectional view of essential parts of a wooden door according to Example 2 of the present invention.

FIG. 4 is an enlarged sectional view of essential parts of a wooden door according to Example 3 of the present invention.

FIG. 5 is a perspective view showing the outline of a wooden door according to Example 4 of the present invention.

FIG. 6 is an enlarged sectional view of essential parts of a wooden door according to Example 4 of the present invention.

### DESCRIPTION OF THE PREFERRED EMBODIMENTS

The present invention will now be described in detail based on its embodiments.

The core material of the present invention is structured to obviate the necessity for a reinforcement such as a skeleton or a framing. Concretely, the core material is characterized in that it has a structure in which three wooden plates are laminated, and that the thickness of the wooden plate located interiorly (called the inner wooden plate) is larger than the thickness of the wooden plate located exteriorly (called the outer wooden plate). By these measures, warpage of the core material can be effectively prevented (curtailed). Particularly when the core material of the present invention is applied, as a core material for a wooden door, to the structure of the wooden door, warpage of the wooden door can be effectively prevented. However, the present invention is not limited to a core material for a wooden door, but is applied to a structure requiring a core material, whereby the shape stability of the structure can be enhanced. Examples of the structure include house furnishings such as the top panel of a table and a shelf, building materials such as a floor covering material and a wall material, or lining materials or interior decoration materials for means of transportation, such as an automobile or a ship. The core material of the present invention can be applied as their core materials.

The thickness of the inner wooden plate is rendered preferably at least 1.5 times, more preferably at least 2.0 times, that of the outer wooden plate. By so doing, the core material can be effectively prevented from warping.

The core material is, preferably, a laminate constructed by laminating an odd number of, for example, three wooden plates, and more preferably, a three-layer crosswise (irregularly crosswise) laminate formed by laminating three wooden plates, with the grains of the wooden plates being crossed. By so doing, the core material can be more effectively prevented from warping.

The wooden plate constituting such a core material may be a one-piece plate or a laminated or glued plate. The material for the wooden plate is, for example, a plate material such as paulownia, Japanese cedar or Cryptomeria japonica, or Aphananthe aspera. Of these plates, the preferred plate is one comprising a wood having a specific gravity of 0.3 or lower, concretely, a paulownia plate comprising a paulownia material. This is because the paulownia material is less likely to warp than other woods, and is lighter in weight. In the present invention, therefore, the core material is, preferably, a paulownia core material composed of paulownia plates laminated together and, more preferably, a paulownia core material which is a three-layer crosswise laminate composed of three paulownia plates, especially, a three-layer crosswise laminate (three-paulownia-ply irregularly crosswise laminate) comprising three paulownia plates in which the direction of the grain of the inner paulownia plate is a course direction, and the direction of the grain of the outer paulownia plate is a wale direction. Because of these features, the paulownia core material can be more effectively prevented from warping. Of course, the present invention is not limited to these modes, and it is permissible to use a paulownia plate as the inner wooden plate, and use a plate comprising a wood other than paulownia as the outer wooden plate.

In the present invention, as described above, the three wooden plates are laminated to form the core material, and the thickness of the inner wooden plate is rendered larger than the thickness of the outer wooden plate. Thus, the core material can be effectively prevented from warping in an environment where the difference in temperature between the front side and the back side of the core material is great, even without providing a reinforcement, such as a skeleton or a framing, in the core material.

In the present invention, moreover, the above-mentioned core material is used as a core material for a wooden door to construct a wooden door, whereby the door can be effectively prevented from warping. When a paulownia core material is used as the core material for the wooden door, the door exhibits excellent fire resistant performance in comparison with doors using, for example, a wood other than paulownia, a laminated material, or an L.V.L. plywood. Thus, the wooden door having the paulownia core material according to the present invention can be used as a fireproof wooden door.

Furthermore, according to the present invention, no reinforcement is necessary when preparing the wooden door. Thus, the wooden door can be produced efficiently by use of the core material for the wooden door, the core material being composed of the three wooden plates and having the thickness of the inner wooden plate larger than the thicknesses of the outer wooden plates. The thus produced wooden door has the core material effectively prevented from warping, so that the warpage of the door itself can be effectively prevented. Also, the number of the members making up the door is so small that the wooden door can be realized at a low cost.

For example, according to the present invention, no reinforcement is needed. Thus, the manufacturing cost for the above-described core material, or the core material for the wooden door, or the wooden door can be reduced to one-third of the manufacturing cost for the conventional core material or the conventional wooden door which has a reinforcement.

Besides, the conventional production line can be used unchanged, thus producing the effect of making capital investment unnecessary. If a production line is newly introduced, no equipment is required for providing the reinforcement. Thus, initial investment can be markedly decreased.

In addition, a surface material maybe joined to both surfaces or one surface of the core material for the wooden door to constitute the wooden door. In this case, the surface material is not limited. For example, a solid natural wood, which is a wood used unchanged, is acceptable, but a plywood may be used. By so doing, a solid door can be prepared at a low cost, an improved texture is imparted, an upgraded appearance is shown, and the value of the product can be increased.

In the present invention, moreover, the wooden door may be one having a waterproof sheet provided between the surface material and the core material for the wooden door. By this measure, moisture present inside the core material for the wooden door is blocked from seeping (moving) to the outside by means of the waterproof sheet. As a result, the movement of moisture inside the core material for the wooden door is confined only in the core material for the wooden door, and the migration of the moisture to the surface material located externally is inhibited. Consequently, warpage of the door can be prevented further effectively.

As the waterproof sheet, there can be named a resin sheet, and a sheet of paper or cloth coated with a resin or a water-repellent paint, concretely, a VS sheet, and a VR sheet. Alternatively, a resin sheet having paper laminated thereto may be used. Examples of the resin sheet are sheets of polyethylene, polypropylene, polyvinylidene chloride, polyester, and nylon. The waterproof sheet preferably has moisture permeability of 20 (g/m²·24 hours) or less, more preferably 10 (g/m²·24 hours). The thickness of the waterproof sheet may be, for example, a thickness enough to effectively prevent warpage of the core material for the wooden door, concretely, a thickness as large as 30 μm or more. The waterproof sheet may be adhered via an adhesive; for example, the waterproof sheet maybe adhered under the pressure of a press, while being interposed between the core material for the wooden door and the surface material.

The waterproof sheet having the above features maybe provided at least between the core material for the wooden door and the surface material. Needless to say, however, this configuration is not limitative, and the waterproof sheet may be provided between the wooden plates constituting the core material for the wooden door, concretely, between the inner wooden plate and the outer wooden plate. By so doing, the migration of moisture from inside the core material for the wooden door to the outside can be prevented more effectively, and warpage of the door can be more reliably prevented.

However, the core material or the core material for the wooden door according to the present invention is a laminate formed of the three wooden plates, and the thickness of the inner wooden plate is rendered larger than the thickness of the outer wooden plate, as described earlier. Thus, it goes without saying that warpage of the core material, or the core material for the wooden door, or the wooden door can be fully prevented, without using the waterproof sheet.

Since warpage of the entire door can be prevented, no reinforcement for preventing the warpage of the core material for the wooden door is required in the wooden door of the present invention. That is, warpage of the entire door can be effectively prevented, even when a reinforcement is not provided so as to surround the core material.

With the present invention, moreover, the wooden door is constructed from the core material requiring no reinforcement. Thus, compared with the conventional wooden door composed of a core material having a reinforcement, the wooden door of the present invention can decrease vibrations of the core material caused by sound waves to obtain excellent sound insulation performance in the plane direction.

Also, a paulownia plate has a much lower thermal conductivity than other woods. The wooden door constructed using a paulownia core material essentially consisting of such a paulownia plate can yield excellent heat insulation performance as compared with a core material composed of a wooden plate comprising a wood other than paulownia.

The conventional wooden door (flush door) , which comprises a core material composed of square timbers combined in a lattice form, and decorative panels joined to both surfaces of the core material, has numerous spaces inside the door. Since heat and vibrations (sound waves) pass via these spaces, the sound insulation performance and the heat insulation performance of the conventional wooden door are low. In some of the conventional wooden doors, the spaces inside the door are packed with glass wool, rock wool, or paper core. By contrast, the wooden door of the present invention, has neither spaces nor gaps inside the door, in comparison with the flush door or the door having a framework, and thus can afford excellent sound insulation performance and heat insulation performance.

The inventor has also focused on the fact that a paulownia material inherently has a very high restoring force as compared with other woods. In this view, the inventor has constructed a paulownia core material of the above-mentioned structure with the use of a paulownia plate having such a characteristic nature, has directly fixed an anchor member to the end surface of the paulownia core material without using a reinforcement for prevention of warpage, and has mounted a hinge via the anchor member. By so constructing the wooden door using the paulownia core material of the present invention, the number of the components of the door can be decreased, and the cost can be markedly reduced. Since the hinge is mounted by the anchor member, moreover, a sufficient binding force on the paulownia core material and the hinge can be ensured for a long term.

As the anchor member used for mounting the hinge in the present invention, an example is an anchor member having a tapped portion into which a countersunk screw is screwed to attach the hinge to the anchor member. In the present invention, moreover, it is preferred to provide a plurality of protrusions on the outer peripheral surface of the anchor member. When the anchor member having the plurality of protrusions on its outer peripheral surface (anchor member with a rasp nut) is fixed to the end surface of the paulownia core material, the plurality of protrusions bite into the paulownia core material, whereafter the high restoring force of the paulownia material clamps the anchor member against the paulownia core material, thereby enhancing the binding force on the anchor member and the paulownia core material.

The present invention will, be described in further detail based on the following examples:

### EXAMPLE 1

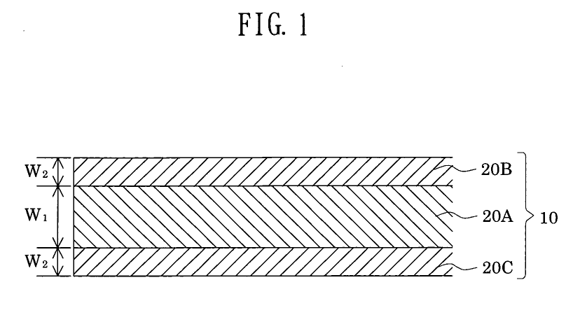

FIG. 1 is an enlarged sectional view of essential parts of a core material according to Example 1 of the present invention. As shown in the drawing, a core material 10 of the present example comprised a paulownia core material which was a laminate of three paulownia plates 20A, 20B and 20C laminated together, concretely, a three-layer crosswise laminate formed by laminating the three paulownia plates 20A, 20B and 20C, with the grains of these plates being crossed. In the present example, the direction of the grain of the inner paulownia plate 20A was a course direction, and the direction of the grain of each of the outer paulownia plates 20B and 20C was a wale direction.

In the present invention, the thickness W₁ of the inner paulownia plate 20A was rendered larger than the thickness W₂ of each of the outer paulownia plates 20B and 20C. Concretely, in the core material 10 of the present example, the thickness W₁ of the inner paulownia plate 20A was set at about 14 mm, and the thickness W₂ of each of the outer paulownia plates 20B and 20C was set at about 8 mm. That is, the thickness W₁ of the inner paulownia plate 20A was set at about 1.75 times the thickness W₂ of each of the outer paulownia plates 20B and 20C.

### Test Example 1

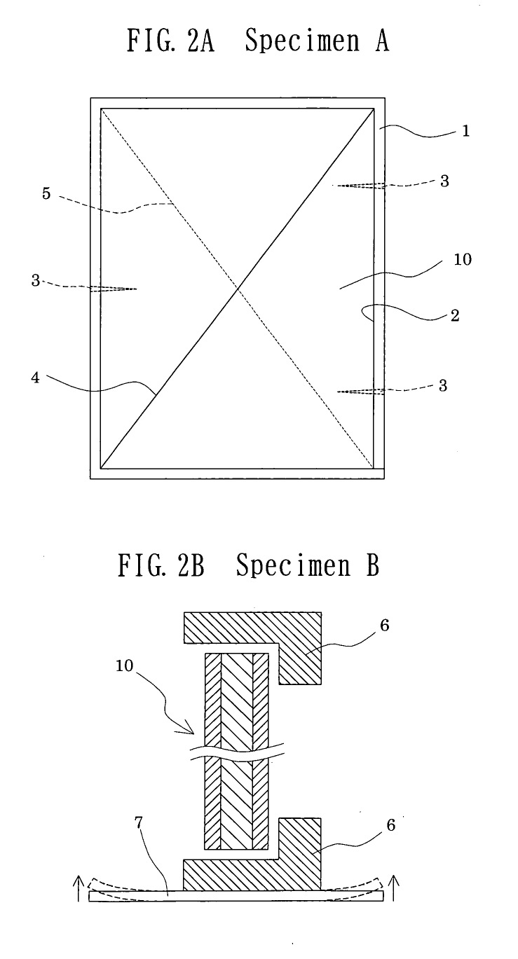

Two of the core materials 10 which were the above-described paulownia core materials were rendered ready for use. One of the core materials 10 was used as Specimen A, and the other core material 10 was used as Specimen B, and a test on the shape stability of these Specimens A and B was conducted under the conditions to be described below. FIGS. 2A and 2B are views showing the status of installation of Specimens A and B in the test on their shape stability.

In connection with Specimen A, as shown in FIG. 2A, the core material 10 was fitted in an opening portion 2 of a frame body 1, and its end surfaces were fixed at three locations by fixing screws 3. Then, a first measuring yarn 4 was fixed to a pair of corner portions diagonally opposing each other on the front side of Specimen A, while a second measuring yarn 5 was fixed to a pair of corner portions diagonally opposing each other on the back side of Specimen A, the second measuring yarn 5 crossing the first measuring yarn 4. In connection with Specimen B, on the other hand, the core material 10 was placed in a notch portion of a frame body 6, which had been used for ten-odd years as a picture frame without warping and which comprised a natural wood, and this combination of the core material 10 and the frame body 6 was placed on a pedestal 7 comprising a natural glued wood.

First, Specimens A and B were allowed to stand for 6 hours in an environment at a subzero temperature of 7° C. and a humidity of 70 to 80% (test environment a). Then, in a room at a room temperature of 25° C. and a humidity of 20%, Specimens A and B were heated for 2 hours, with the surfaces of Specimens A and B being exposed to warm air of 70° C. by a halogen irradiator (test environment b). Then, Specimens A and B were allowed to stand for 2 hours in an outdoor environment at a subzero temperature of 8° C. and an outside air humidity of 80% (test environment c). Then, in a room at a room temperature of 25° C. and a humidity of 20%, Specimens A and B were heated for 2 hours, while being exposed to warm air of 70° C. by a halogen irradiator (test environment d). Then, Specimens A and B were allowed to stand for 10 hours in a room at a room temperature of 24° C. and a humidity of 20% (test environment e). Finally, Specimens A and B were moved to an environment where these specimens were exposed to direct sunlight through glass so that the surface temperature of Specimens A and B reached 50 to 60° C. upon exposure to the direct sunlight, whereupon Specimens A and B were allowed to stand for 48 hours in an environment at a room temperature of 24 to 26° C. and a humidity of 20% (test environment f)

For comparisons with Specimens A and B, the same core material as that used as the above-described Specimens A and B, except that the thickness of the inner paulownia material was equated to the thickness of the outer paulownia material, was prepared, and used as Specimen C. This Specimen C was subjected to a test involving exposure of Specimen C to the above-described test environments a to f.

After completion of the above tests, the warpage, twisting and dimensions of Specimen A were measured, with the first and second measuring yarns being used as references. Specimen A was found to show no changes from the state before the test. The warpage, twisting and dimensions of Specimen B were also measured, with the end surface of the frame body 6 being used as the measuring point. Specimen B was found to show no changes from the state before the test. On the other hand, Specimen C warped greatly about 3 hours after the start of exposure to the test environment a. The pedestal (natural glued wood) 7 for Specimen B warped markedly at the time point of exposure to the test environment d, failing to keep stability.

Then, Specimens A and B exposed to the above-described test environments a to f were moved, as such, to an environment at a subzero temperature of 15° C. and a humidity of 70% and without external solar radiation, and were allowed to stand there for 2 hours. Then, Specimens A and B were irradiated with direct sunlight so that their surface (front side) temperature reached 60° C. and the temperature of their back side (the surface in the shade) became 5° C. below zero. Specimens A and B were allowed to stand for 3 hours in this environment (test environment g).

Then, an exposure test was conducted for 2 days in an outdoor environment which had a humidity of 80%, an air temperature of 2° C. to a subzero point of 15° C. and where Specimens A and B had a surface temperature of 50° C. when exposed to solar radiation (test environment h).

Finally, in a room at a room temperature of 25° C. and a humidity of 25%, Specimens A and B were heated for 3 to 4 hours, with warm air of 70° C. being directed at their surfaces by a halogen irradiator (test environment i).

After Specimens A and B were exposed to the test environment g, the test environment h, and the test environment i described above, the warpage, twisting and dimensions of Specimen A were measured, with the first and second measuring yarns being used as references. The warpage, twisting and dimensions of Specimen B were also measured, with the end surface of the frame body 6 being used as the measuring point. In any of the above conditions, the states of Specimens A and B were found to show no changes from the states before the tests.

In the light of the above findings, the core material 10 of the present example can effectively prevent warpage, twisting, and dimensional changes for a long term, even when exposed to an environment where very severe temperature changes occur. Hence, if the core material 10 of the present example is applied to a door in a room, or is applied as a core material for an external door whose one face is exposed to the outside air in regions with extreme coldness or fierce heat, a wooden door showing excellent shape stability can be realized.

### Test Example 2

A test on the shape stability of Specimen B as described above was further conducted under the following severe conditions: Specifically, Specimen B was allowed to stand for 8 hours in the outside air at 7° C. below zero and at humidity of 70 to 80%. Then, Specimen B was laid on a cold floor, and humidity on the front side of Specimen B opposite to its surface facing the floor surface was set at 20%. In this condition, Specimen B was heated for 2 hours, with warm air of 70° C. being directed at the front side of Specimen B by a halogen irradiator.

After completion of this test, the warpage, twisting, and dimensional changes of Specimen B were measured, showing that an end portion of Specimen B was about 3 mm apart from the floor surface, and the maximum distance between the surface of Specimen B and the first measuring yarn was about 3 mm. These findings showed that the warpage of Specimen B could be kept to a minimum even under such severe conditions.

After completion of the above-mentioned test, Specimen B was moved to the inside of a room, and allowed to stand for 1 hour in an environment at a temperature of 25° C. and a humidity of 20%, whereby Specimen B was restored to the state before start of the test. As noted here, even when a warp measuring as small as several millimeters occurred in the core material 10 of the present example as Specimen B under severe conditions, this material was restored to the original state in a relatively short time. Thus, the core material was demonstrated to have excellent shape stability.

### Test Example 3

A test on the shape stability of Specimen B as described above was further conducted under the following severe conditions: Specifically, Specimen B was laid on the snow, and exposed to direct sunlight at 8° C. below zero in the snow to have a surface temperature of 60° C. In this environment where the temperature difference between the front side and back side of Specimen B was set at 68° C., Specimen B was allowed to stand for 3 hours. When warpage of Specimen B was measured, it was found that Specimen B did not warp at all.

Then, Specimen B was moved into a room, where Specimen B was heated for 2 hours, with warm air of 70° C. being directed at the front side of Specimen B by a halogen irradiator.

After completion of this test, the warpage, twisting, and dimensional changes of Specimen B were measured, showing that an end portion of Specimen B was about 6 mm apart from the floor surface, and the maximum distance between the surface of Specimen B and the first measuring yarn was about 6 mm. These findings showed that the warpage of Specimen B could be kept to a minimum even under such severe conditions.

After completion of the above-mentioned test, Specimen B was moved to the inside of a room, and allowed to stand for 80 minutes in an environment at a temperature of 25° C. and a humidity of 20%, whereby Specimen B was restored to the state before start of the test. As noted here, even when a warp measuring as small as several millimeters occurred in the core material 10 of the present example as Specimen B under severe conditions, this material was restored to the original state in a relatively short time. Thus, the core material was demonstrated to have excellent shape stability, as in the above-mentioned Test Example 2.

### EXAMPLE 2

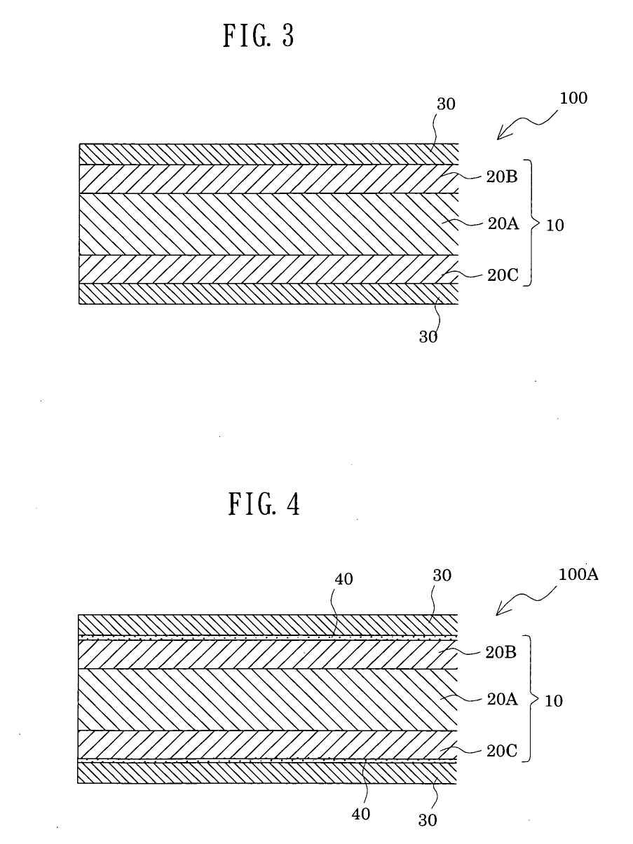

FIG. 3 is an enlarged sectional view of essential parts of a wooden door according to Example 2 of the present invention. As shown in the drawing, a wooden door 100 of the present example had no framing, and comprised the core material 10 of Example 1 mentioned above, and decorative panels 30 joined to both surfaces of the core material 10, each of the decorative panels comprising a paulownia plate having a thickness of the order of 5 mm. In the wooden door 100 of this configuration, the thickness of the inner paulownia plate 20A is larger than the thicknesses of the outer paulownia plates 20B, 20C. Thus, the occurrence of warpage in the entire door can be effectively prevented.

### EXAMPLE 3

FIG. 4 is an enlarged sectional view of essential parts of a wooden door according to Example 3 of the present invention. As shown in the drawing, a wooden door 100A of the present example had the same configuration as that in Example 2 mentioned above, except that waterproof sheets 40 were provided between the core material 10 and the decorative panels 30. A waterproof sheet having moisture permeability of 7 to 10 (g/m²·24 hours) and a thickness of 40 μm (VS Sheet, TOPPAN COSMO) was used as the waterproof sheet 40. The moisture permeability was measured in compliance with the JIS Z 0208 Cup Method (40° C., 90% RH).

By so providing the waterproof sheet 40 between the core material 10 and each decorative panel 30, moisture present inside the core material 10 can be blocked from moving to the outside, i.e., the decorative panel 30, by means of the waterproof sheet 40. As a result, warpage of the wooden door 100A can be prevented further effectively.

### EXAMPLE 4

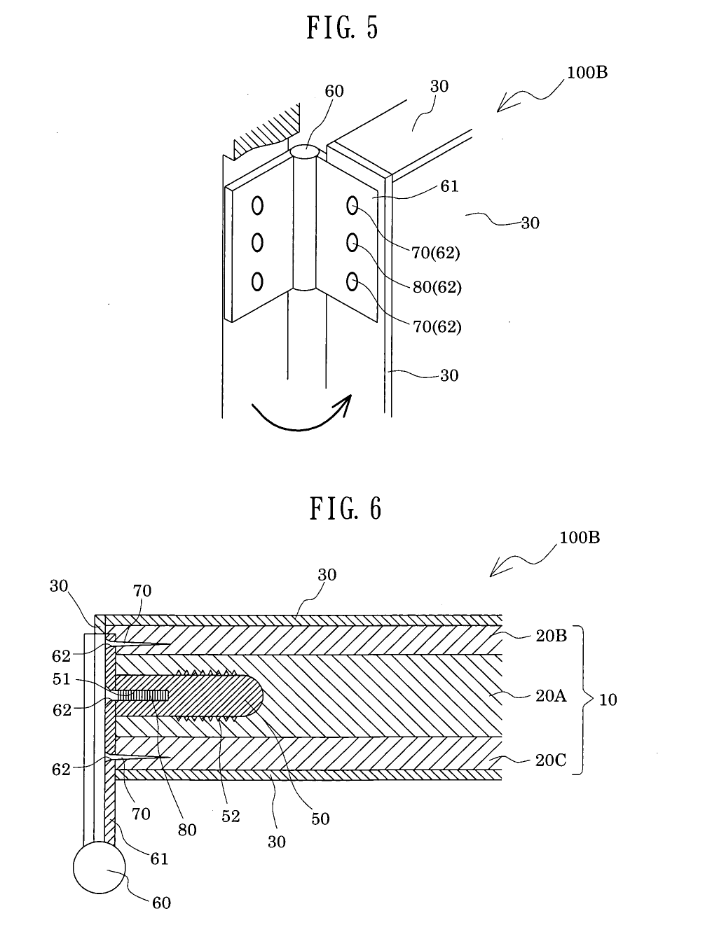

FIG. 5 is a perspective view showing the outline of the wooden door using the core material of the present invention. FIG. 6 is an enlarged sectional view of essential parts of the wooden door shown in FIG. 5. As shown in the drawings, a wooden door 100B of the present example has the decorative panels 30 further joined to the end surfaces of the wooden door 100 of Example 2 described above, and has a hinge 60 mounted on the end surface of the core material 10 via an anchor member 50.

Concretely, the anchor member 50 for mounting the hinge 60 on the end surface of the core material 10 is fixed to the inner paulownia plate 20A, and a tapped hole (9 φ, 50 mm) 51 is formed in the anchor member 50. The dimensions of the anchor member 50, such as entire length and outer diameter, may be adjusted as appropriate, for example, according to the weight of the door or the dimensions of the hinge 60 and the core material 10. A plurality of through-holes 62 are provided in each of slats 61 of the hinge 60, and the hinge 60 has wood screws 70 driven into the core material 10 via the through-holes 62. A countersunk screw 80 is threaded into the tapped hole 51 of the anchor member 50, whereby the hinge 60 is directly mounted on the end surface of the core material 10. In the present example, three of the through-holes 62 are arranged parallel in each slat 61, and the through-holes 62 on both sides are used for the wood screws 70, while the middle through-hole 62 is used for the countersunk screw 80. Of course, the positions of the wood screws 70 and the countersunk screw 80 are not limited to these positions. For example, the wooden door may be constructed such that through-holes for wood screws are provided at the four corners of the slat, and a through-hole for a countersunk screw is provided at nearly the center of the slat. By so doing, the wooden door can be realized in which the hinge is fixed to the core material more firmly.

In the present example, as described above, the hinge 60 is fixed by the anchor member 50. Thus, there is no need for a reinforcement (rail frame or stile frame) as a framework for the core material, which is intended to correct the warpage of the core material 10 or fix the hinge 60. As a result, the number of the components can be decreased to reduce the cost markedly. Since the hinge 60 is mounted by the anchor member 50, moreover, a sufficient binding force on the core material 10 and the hinge 60 can be ensured for a long term.

Furthermore, a plurality of protrusions 52 are provided on the outer peripheral surface of the anchor member 50 of the present example. Thus, the biting of the plurality of protrusions 52 into the core material 10, and the subsequent restoring force of the paulownia plate 20A act to enable the anchor member 50 to be firmly fixed to the end surface of the core material 10. That is, a sufficient joining force on the hinge 60 and the core material 10 can be ensured for a long term.

In fixing the anchor member 50 to the inner paulownia plate 20A as in the present example, wooden plates comprising a wood other than a paulownia material may be used instead of the outer paulownia plates 20B, 20C.

The embodiments of the present invention have been described above, but the invention is not limited to these embodiments. It should be understood that the invention can be subject to changes, substitutions or alterations without departing from the spirit and scope of the invention as defined by the appended claims.

What is claimed is:

1. A wooden door having no framing, and comprising:
a core material for a wooden door, the core material
having a structure in which three paulownia plates are laminated,
having a shape of a door,
being structured such that a thickness of the inner paulownia plate is larger than a thickness of each of the outer paulownia plates, and
having a three-layer crosswise laminate structure in which the three paulownia plates are laminated, with grains of the three paulownia plates being crossed, a direction of the grain of the inner paulownia plate is a course direction, and a direction of the grain of each of the outer paulownia plates is a wale direction orthogonal to the direction of the grain of the inner paulownia plate; and
a surface material joined to a surface of the core material for a wooden door;
wherein a hinge is mounted on the core material.

2. The wooden door according to claim 1, wherein the thickness of the inner wooden plate is at least 1.5 times the thickness of the outer wooden plate.

3. The wooden door according to claim 1, wherein the thickness of the inner wooden plate is at least 2.0 times the thickness of the outer wooden plate.

4. The wooden door according to claim 1, wherein the hinge is fixed to an anchor member mounted on an end portion of the core material for a wooden door.

5. The wooden door according to claim 2, wherein the hinge is fixed to an anchor member mounted on an end portion of the core material for a wooden door.

6. The wooden door according to claim 3, wherein the hinge is fixed to an anchor member mounted on an end portion of the core material for a wooden door.
